(19) United States
(12) Patent Application Publication
(10) Pub. No.: US 2004/0022204 A1
(43) Pub. Date: Feb. 5, 2004

(54) Full duplex/half duplex serial data bus adapter

(76) Inventor: Matthew Trembley, Grayson, GA (US)

Correspondence Address: LSI LOGIC CORPORATION, 1621 BARBER LANE, MS: D-106 LEGAL, MILPITAS, CA, 95035, US

(21) Appl. No.: 10/210,228

(22) Filed: Jul. 31, 2002

(51) Int. Cl. H04B 3/30

(52) U.S. Cl. 370/285; 370/296

(57) ABSTRACT

An adapter permits bi-directional communications between a full duplex mode, two data wire serial data bus and a half duplex mode, one data wire serial data bus. Settings or preferences for the full duplex mode bus may be set by the half duplex mode bus using a command format. Processing by the adapter controller may be interrupt driven, except during the processing of the half duplex mode serial data bus, when the interrupts may be disabled.

### FIELD OF THE INVENTION

The present invention generally relates to the field bus-to-bus adapters, and particularly to an adapter that permits communications between a full duplex mode, two data wire serial bus and a half duplex mode, one data wire serial bus.

### BACKGROUND OF THE INVENTION

Redundant Arrays of Independent Disks improve data storage device performance and reliability by using multiple drives to distribute data. The multiple disk drives of a RAID system act as a single hard drive. Important RAID advantages are greater storage capacity, faster speed of operation, and enhanced reliability. These advantages primarily arise from the ability to perform multiple input/output operations in parallel from the disk drives and the ability to mirror data or use parity.

Communications between a Redundant Array of Independent Disks (RAID) and a personal computer (PC) currently requires Universal Asynchronous Receiver Transmitter (UART) circuitry. The UART is a device within the PC that converts parallel to serial data and serial to parallel data and often controls an RS 232 serial port. A drawback to the use of physical UART circuitry is expense.

Therefore, it would be desirable to provide an economical mechanism for communicatively coupling a PC and a RAID.

### SUMMARY OF THE INVENTION

Accordingly, the present invention is directed to full duplex mode, two data wire serial bus to half duplex mode, one data wire serial bus adapter.

The present invention provides a seamless interface between a full duplex mode, two data wire serial bus and a half duplex mode, one data wire serial bus. A command structure/interface allows preferences to be set for either serial data bus.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 illustrates the basic components of the apparatus of the present invention;

FIG. 2 illustrates the apparatus of the present invention within the context of a serial data bus;

FIG. 3 illustrates a method of the present invention; and

FIG. 4 illustrates a command format of the present invention.

### DETAILED DESCRIPTION OF THE INVENTION

Reference will now be made in detail to the presently preferred embodiments of the invention, examples of which are illustrated in the accompanying drawings.

The present invention presents a method and apparatus for seamless communications between a full duplex mode, two data wire serial data bus and a half duplex mode, one data wire serial data bus. The present invention may be more generally applied to a method and apparatus for seamless communications between two serial data buses. The apparatus may be implemented as an adapter; especially, an adapter for an Inter Integrated Circuit (I2C) bus (or, System Management (SM) bus) and a RS232 bus.

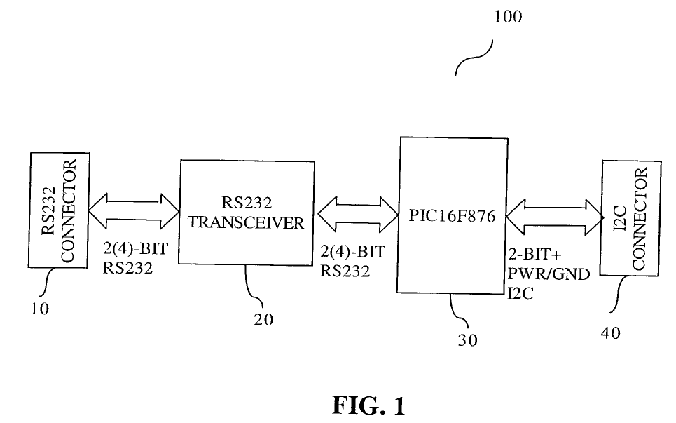

FIG. 1 illustrates an exemplary embodiment of the adapter 100 of the present invention. The adapter may be implemented on a circuit board. The circuit board includes a full duplex mode connector 10, such as an RS232 bus connector, and a half duplex mode connector 40, such as an I2C bus connector or a System Management (SM) bus connector. Between the two connectors, processing circuitry transfers data between devices connected to both buses. A microcontroller 30, such as a PIC16F876, controls the processing. Also included is a full duplex mode transceiver 20. Input from either the full duplex mode serial data bus or the half duplex mode serial data bus may interrupt the microcontroller. The input is then stored. An algorithm used by the microcontroller is then employed to transfer the stored input to the receiving serial data bus. In a specific implementation, the adapter has a DB9 connector, a MAX232 Transceiver, a microcontroller, and a 4 pin handset jack (I2C). Instead of a DB9 connector, a different connector for supporting CTS/RTS hardware flow control may be used. Also, instead of a 4 pin handset jack, a connector, including a serial data pin, may include pins for a serial clock, power, and ground.

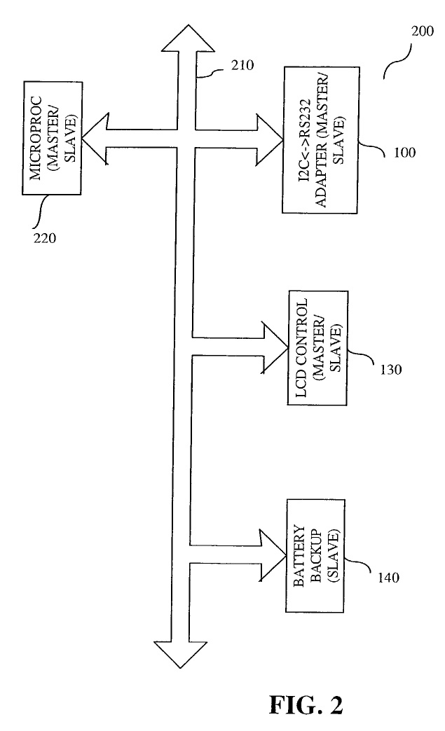

FIG. 2 illustrates an exemplary embodiment 200 of the serial bus 210 of the present invention. A microprocessor or other processor 220 may be used to provide many operational functions for the system. The bus-to-bus adapter 130 may be used to communicate with various devices on a linked bus. These devices may be legacy devices that are connected to an existing bus or may be a local area network. A display device 140 may have an operator control interface, such as a graphical user interface, for communicating with the system. A back up power source 140, such as a battery backup, may be employed. Alternatively, the primary power source may be battery operated. This arrangement allows portable devices to use the serial bus. Interface devices may be provided that are connected to the bus which wirelessly communicate with another device, such as a portable, hand held device.

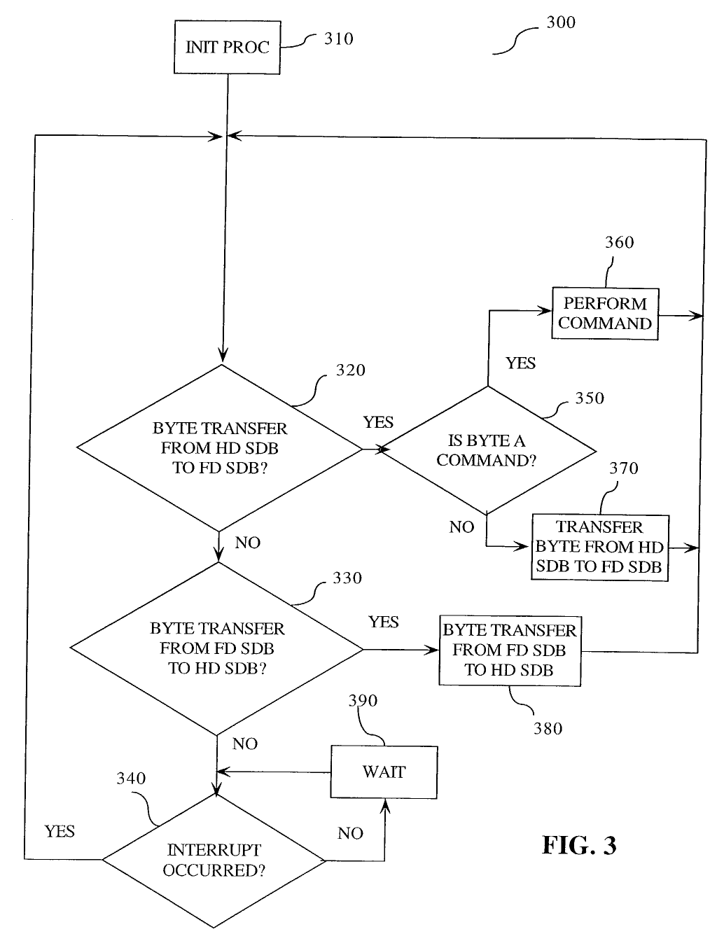

FIG. 3 illustrates a flow diagram of certain processing steps of the present invention. The microcontroller is initialized once per power up, per step 310. Initializing the microcontroller may include setting default addresses for the adapter for the serial data buses, enabling data transfer rates, enabling receiver and transmitter modes, enabling interrupts, and the like. Step 320 determines if a byte transfer is to be performed between the half duplex serial data bus (HD SDB) to the full duplex serial data bus (FD SDB). The term byte is not restricted to eight bits, but may more generally describe a transferable bit pattern. If a byte transfer to the full duplex serial data bus is authorized, then a determination is made as to whether the byte is a command, per step 350. If it is not, the byte is transferred from the half duplex serial data bus to the full duplex serial data bus, per step 370. Otherwise, a command is performed, per step 360. Processing returns to step 320.

For a byte transfer, it may be desirable that the recipient device of the byte acknowledges receipt of the byte to the sending device. If a determination is made that no byte transfer is to occur from the half duplex mode serial data bus to the full duplex mode data bus, a determination is made as to whether there is a byte transfer to be made from the full duplex mode serial data bus to the half duplex mode serial data bus, per step 330. If so, the byte is accordingly transferred, per step 380, and processing returns to step 320. Otherwise, a determination is made as to whether there is an interrupt, per step 340. If not, then the microcontroller waits, per step 390. Otherwise, processing proceeds to step 320.

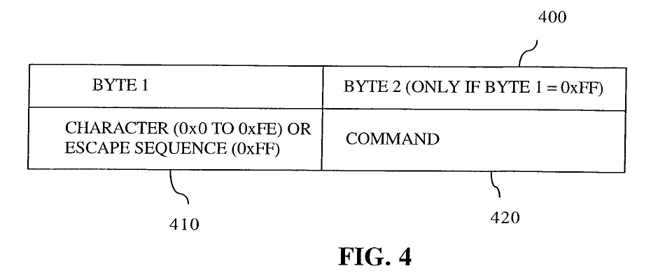

An example of the protocol between a device in master mode and a device in slave mode on the half duplex mode serial data bus is illustrated in FIG. 4. When adapter 100 is in slave mode, protocol may be limited to one byte, such as a character. The one byte character may originate from a monitor station's keyboard via a terminal program. The terminal program's characters may be interpreted as one-byte characters to be sent out the half duplex mode transceiver 20. Certain bytes may be restricted for commands from the master mode device of the half duplex mode serial data bus. For example, 0×FF may be used as an internal escape sequence for sending commands from the master mode device on the half duplex mode serial data bus to the adapter in slave mode. The command may be the next byte after the internal escape sequence character, as shown in FIG. 4. Table 1 provides an exemplary list of commands available. Unused command values may be reserved for future commands. This example may be implemented between a variety of devices, such as a microprocessor with a RS232<->I2C Adapter.

The implementation of the present invention may entail retrofitting current devices on the bus. In certain cases, it may be necessary to replace hardware. Otherwise, the changes may be programmed into device memory, such as an electrically erasable programmable read only memory. The present invention may be implemented in software, hardware, and/or firmware.

A portion of exemplary pseudo code for performing operations in the present invention is provided below. Other variations of implementing the process steps are within the scope and spirit of the present invention. The pseudo code presented below includes a main routine that runs continuously. The main routine provides for a one-time initialization of registers. Thereafter, various variables are checked for changes in value to perform a half duplex bus function or a full duplex bus function.

Main routine
Initialize processor;
Begin Infinite Loop
If slave mode, then clear watchdog timer;
Begin I2C
If data to send and I2C bus not busy, then

Disable interrupts;
If data received,

Preserve one byte of data at time of interrupt;

Else if address received

Clear address

End if

Set I2C master mode;
Re enable interrupts;
Initiate master transmit mode;

Endif
End I2C
Begin RS 232
If buffer not empty (not necessarily data since it may be a command)

If data and not busy

then transmit to RS 232 and reenable I2C (if I2C is halted)

at a certain level

else if command

then perform command

reenable I2C

end inner if

end outer if
End RS 232
End Infinite Loop

A parallel interrupt routine (not shown) changes the values of variables in the main routine so that different sections of the main routine code may be processed at different times, according to the state of various variables. Full duplex mode serial data bus and half duplex mode serial data bus modules may reside in microcontroller 30. These modules may initiate interrupts when a character is sent or received on the full duplex mode serial data bus side, when a half duplex mode serial data bus address is recognized, or when the half duplex mode serial data bus master state machine progress to the next state.

TABLE 1

| Command | Device Action |
|---|---|
| 0 × 00 | Set microprocessor slave address to the |
| | command value |
| ↓ | |
| 0 × 7F | Set microprocessor slave address to the |
| | command value |
| 0 × B0 | Set UART baud rate to 9600 |
| 0 × B1 | Set UART baud rate to 19200 |
| 0 × B2 | Set UART baud rate to 38400 |
| 0 × B3 | Set UART baud rate to 57600 |
| 0 × D0 | Return Device ID and Version Information |
| 0 × F0 | Set UART flow control to off |
| 0 × F1 | Set UART flow control to on |
| 0 × FF | Send the character 0 × FF through the |
| | UART |

In general, each serial data bus may have different sets of commands. As shown in Table 1, commands for the full duplex bus may include setting a slave mode device address, setting a baud rate, return version information about the slave mode device, or setting the UART flow control to on or off. A command interpreter may be included in the processor for the serial data bus. The command may originate from and be transmitted across the half duplex mode serial data bus side. In a particular embodiment, a byte that follows the escape sequence “FF” is a command byte. If the command byte is “FF”, a single “FF” is transmitted across the serial data bus and is not treated as an extension for more commands. That is, any single character is transmitted from one side to the other, unless the byte “FF” is received on the half duplex mode side in which case the next byte is interpreted. For example, “FF B0” is interpreted to set the full-duplex mode serial data bus speed. If “FF FF” is transmitted on the bus, then one “FF” is transmitted to the other side. For example, “FF FF FF FF FF B0 FF FF A0 B0 FF F0 FF FF” is interpreted as “send FF, send FF, set baud, send FF, send A0, send B0, turn flow control, send FF”. Undefined command bytes are treated as a no op. It is to be understood that when the first byte in FIG. 4 is equal to “FF” (escape sequence), it serves as a command delimiter byte.

Commands are generally one byte in length. Additional commands may be added as desired. Alternatively, commands may be differently sized or variably sized. Varying command sizes may require that the first byte of the command indicate the length of the command, unless a byte character were chosen to represent a command end character.

In addition to the continuously running main routine, other routines may be employed which permit read and write operations for the half duplex mode (e.g., I2C) serial data bus and the full duplex mode (e.g., RS 232) serial data bus. These routines may distinguish whether a last byte was an address or data and may perform operations if no acknowledge is received.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. An adapter for communications between a full duplex mode serial data bus and a half duplex mode serial data bus, comprising:
a full duplex mode serial data bus connector having settings which are settable through a command mode;
a transceiver coupled to the full duplex mode serial data bus interface;
a processor coupled to the transceiver, the processor controlling the adapter through a program that is interrupt driven; and
a half duplex mode serial data bus connector coupled to the processor.

2. The adapter for communications between the full duplex mode serial data bus and the half duplex mode serial data bus of claim 1, wherein the half duplex mode serial data bus is an Inter Integrated Circuit bus.

3. The adapter for communications between the full duplex mode serial data bus and the half duplex mode serial data bus of claim 1, wherein the full duplex mode serial data bus is an RS232 serial data bus.

4. The adapter for communications between the full duplex mode serial data bus and the half duplex mode serial data bus of claim 1, wherein the full duplex mode serial data bus connector is a DB9 connector.

5. The adapter for communications between the full duplex mode serial data bus and the half duplex mode serial data bus of claim 1, wherein the half duplex mode serial data bus connector is a four pin handset jack.

6. The adapter for communications between the full duplex mode serial data bus and the half duplex mode serial data bus of claim 1, wherein the half duplex mode serial data bus has one less wire for data byte transmission than the full duplex mode serial data bus.

7. A method for communications between a full duplex mode serial data bus and a half duplex mode serial data bus, comprising the steps of:
initializing a set of registers;
enabling interrupts; and
performing an infinite loop for processing incoming data and commands which includes the step of initiating an interrupt for at least one of the group of events consisting of a character sent on the full duplex mode serial data bus, a character received on the full duplex mode serial data bus, recognition of a half duplex mode serial data bus address, and progression of the half duplex mode state machine to a next state.

8. The method for communications between the full duplex mode serial data bus and the half duplex mode serial data bus of claim 7, further comprising disabling interrupts for a half duplex mode serial data bus operation and enabling interrupts after the half duplex mode serial data bus operation is completed.

9. The method for communications between the full duplex mode serial data bus and the half duplex mode serial data bus of claim 7, further comprising the step of storing incoming data and commands in a data buffer when an interrupt occurs for the half duplex mode serial data bus.

10. The method for communications between the full duplex mode serial data bus and the half duplex mode serial data bus of claim 7, further comprising the step of performing an operation for the full duplex mode serial data bus.

11. The method for communications between the full duplex mode serial data bus and the half duplex mode serial data bus of claim 10, wherein the operation is a data transfer operation.

12. The method for communications between the full duplex mode serial data bus and the half duplex mode serial data bus of claim 11, wherein the data transfer operation is a data transfer from the half duplex mode serial data bus to the full duplex mode serial data bus.

13. The method for communications between the full duplex mode serial data bus and the half duplex mode serial data bus of claim 10, wherein the operation is a command.

14. The method for communications between the full duplex mode serial data bus and the half duplex mode serial data bus of claim 7, wherein the step of initializing a set of registers includes setting the half duplex mode serial data bus address to a default value.

15. The method for communications between the full duplex mode serial data bus and the half duplex mode serial data bus of claim 13, wherein the command sets a baud rate for the full duplex mode serial data bus.

16. The method for communications between the full duplex mode serial data bus and the half duplex mode serial data bus of claim 7, wherein the half duplex mode serial data bus is an Inter Integrated Circuit bus.

17. The method for communications between the full duplex mode serial data bus and the half duplex mode serial data bus of claim 7, wherein the full duplex mode serial data bus is an RS 232 bus.

18. An adapter for communications between a full duplex mode serial data bus and a half duplex mode serial data bus, comprising:
a full duplex mode serial data bus connector;
a half duplex mode serial data bus connector coupled to the processor; and
a processor coupled to the full duplex mode serial data bus connector and the half duplex mode serial data bus connector.

19. The adapter for communications between the full duplex mode serial data bus and the half duplex mode serial data bus of claim 18, wherein the half duplex mode serial data bus is an Inter Integrated Circuit bus.

20. The adapter for communications between the full duplex mode serial data bus and the half duplex mode serial data bus of claim 18, wherein the full duplex mode serial data bus is an RS232 serial data bus.

21. The adapter for communications between the full duplex mode serial data bus and the half duplex mode serial data bus of claim 18, wherein the full duplex mode serial bus connector has two pins for data byte transfer and the half duplex mode serial bus connector has one pin for data byte transfer.

22. An adapter for communications between a first serial data bus and a second serial data bus, comprising:
a first serial data bus connector having settings that are settable through a first set of commands;
a transceiver coupled to the first serial data bus interface;
a processor coupled to the transceiver, the processor controlling the adapter through a program that is interrupt driven; and
a second serial data bus connector coupled to the processor.

23. The adapter of claim 22, wherein the second serial data bus connector has settings that are settable through a second set of commands.

24. The adapter of claim 22, wherein the second serial data bus is a System Management (SM) bus.

25. The adapter of claim 22, wherein the first serial data bus is an RS 232 bus.

26. The adapter of claim 22, wherein the second serial data bus is an Inter Integrated Circuit bus.

27. The adapter of claim 22, wherein one of the first and second serial data bus connectors is a four wire connector.

28. The adapter of claim 27, wherein the four wire connector has a serial data pin, a clock pin, a power pin, and a ground pin.

29. A method for communications between a first serial data bus and a second serial data bus, comprising the steps of:
initializing a set of registers;
enabling interrupts; and
performing an infinite loop for processing incoming data and commands which includes the step of initiating an interrupt for at least one of the group of events consisting of a character sent on the first or second serial data bus, a character received on the first or second serial data bus, recognition of a first or second serial data bus address, and progression of a state machine to a next state.

30. The method of claim 29, wherein a unique character is dedicated as a command delimiter byte.

31. The method of claim 30, wherein the unique character is an escape sequence character.
